(19) United States
(12) Patent Application Publication
(10) Pub. No.: US 2015/0251721 A1
(43) Pub. Date: Sep. 10, 2015

(54) BICYCLE DAMPING SYSTEM

(71) Applicant: SPECIALIZED BICYCLE COMPONENTS, INC., Morgan Hill, CA (US)

(72) Inventors: Kyle L. Chubbuck, San Jose, CA (US); Andy Ward, Morgan Hill, CA (US)

(73) Assignee: SPECIALIZED BICYCLE COMPONENTS, INC., Morgan Hill, CA (US)

(21) Appl. No.: 14/201,556

(22) Filed: Mar. 7, 2014

(51) Int. Cl. B62K 21/02; B62K 25/04

(52) U.S. Cl. CPC B62K 21/02; B62K 25/04; B62K 2025/041

(57) ABSTRACT

A bicycle damping system is arranged to reduce vibrations that originate at the bicycle wheel and are transmitted to the rider of the bicycle. A bicycle can include a main frame portion, a wheel, and a wheel support. The wheel support can include, but is not limited to: one of a fork, a fork leg, a rear frame portion, a seat stay, and a chain stay. The wheel support can be coupled to the main frame portion at a first end and supporting the wheel at a second end. A damping member can be positioned on an outer surface of the wheel support and a plate can be used to force the damping member into contact with the outer surface. In this way, the system can dampen vibrations introduced to the wheel support by the wheel.

### BACKGROUND OF THE INVENTION

1. Field of the Invention

The present invention generally relates to bicycles. More particularly, the present invention relates to a system configured to reduce vibrations transmitted to a rider of the bicycle.

2. Description of the Related Art

Bicycle riding and racing often take place on less than ideal terrain conditions. For example, bicycle touring and racing may often take place on country roads, which may be unpaved or where the pavement may be rough and irregular, even when new. In more populated areas, a significant portion of paved roads may be damaged and in need of repair. When traversed by the bicycle, these irregular surfaces transmit vibrations to the bicycle. Furthermore, the surface of even relatively new pavement, while acceptable for motor vehicles, may be rough enough to transmit significant vibration to a bicycle. Accordingly, most bicyclists spend at least a significant portion of their riding time traversing rough or irregular surfaces. Vibrations induced by such terrain, if not sufficiently dampened, may be transmitted to the rider of the bicycle. When transmitted to the rider, these vibrations often cause discomfort and fatigue.

Several methods for damping terrain-induced vibrations have been utilized. For example, the bicycle may be equipped with front and/or rear suspension assemblies, which permit the suspended wheel to move against a biasing force relative to the bicycle frame. Although highly favored in some applications, such as bicycles intended primarily for off-road use, such suspension assemblies have generally been unsuccessful in connection with bicycles primarily intended for use on paved surfaces (i.e., road bicycles), where low weight and aerodynamics are considered highly important. Furthermore, such suspension assemblies are intended to absorb large bumps and may not be effective at isolating vibrations due to inherent friction within the assembly, which may prevent movement of the suspension assembly in response to small forces.

In road bicycle applications, it has recently become popular to utilize materials having improved damping properties in comparison to metals to form a portion or all of the bicycle between the wheels and the rider. For example, a composite material of carbon fiber fabric within a resin matrix (“carbon fiber”) is often used in an attempt to isolate road-induced vibrations from the rider of the bicycle. In some instances, the entire frame of the bicycle may be comprised of a carbon fiber material.

Such an arrangement has been more successful in isolating terrain-induced vibrations from reaching the rider of the bicycle in comparison with bicycle frames and components comprised entirely of metal. However, although carbon fiber is lightweight and exhibits improved vibration damping characteristics in comparison to metal, a significant amount of vibration may nonetheless be transferred through components made from carbon fiber.

One proposed solution to carbon fibers undesirable transmission of vibrations is to incorporate an additional material into the carbon fiber fabric that is used to make the final carbon fiber product. For example, a weave of titanium filaments has been incorporated into carbon fiber fabric in an attempt to reduce the amount of vibration that is transmitted through components made of carbon fiber. However, such a solution necessitates a complex manufacturing process and, thus, increases the cost of the final product.

### SUMMARY OF THE INVENTION

Accordingly, a need exists for a cost-effective method of reducing vibrations from being transmitted from the wheels of a bicycle to the rider of the bicycle. A bicycle can include a main frame portion, a wheel, and a wheel support. The wheel support can be coupled to the main frame portion at a first end and supporting the wheel at a second end. A damping member can be positioned on an outer surface of the wheel support and a plate can be used to force the damping member into contact with this outer surface. In this way, the system can dampen vibrations introduced to the wheel support by the wheel. The wheel support can include, but is not limited to: one of a fork, a fork leg, a rear frame portion, a seat stay, and a chain stay.

In some embodiments, a bicycle can comprising a main frame portion, a wheel, a wheel support, a damping member, a plated, and one or more fasteners. The wheel support can be coupled to the main frame portion at a first end and supporting the wheel at a second end. A distance between the first end and the second end can define a wheel support length along a longitudinal axis. The wheel support can have an outer surface forming a plurality of sides extending along the wheel support length. The outer surface can define a first outer perimeter and a second outer perimeter smaller than the first, both perimeters being defined by a plane perpendicular to the longitudinal axis. The outer surface can form a shoulder along a first side of the plurality of sides between the first and second outer perimeters while a second side opposite the shoulder, does not form a shoulder. The damping member can be positioned on the first side of the outer surface at the shoulder and can be generally positioned adjacent a portion of the second outer perimeter. The plate can force the damping member into contact with the first side of the outer surface of the wheel support with at least a portion of the damping member sandwiched between the plate and the wheel support to thereby dampen vibrations introduced to the wheel support by the wheel.

In some embodiments, a bicycle can comprising a main frame portion, a wheel, a wheel support, a damping member, a plated, and one or more fasteners. The wheel support can couple to the main frame portion at a first end and supporting the wheel at a second end, a distance between the first end and the second end defining a wheel support length along a longitudinal axis. The wheel support can have an outer surface forming a plurality of sides extending along the wheel support length. The outer surface can be shaped to form a cutout from a continuous surface on either side of the cutout wherein a line extending at a top of the cutout from a first end to a second end of the cutout along the wheel support length aligns with the continuous surface on either side of the cutout. The cutout according to some embodiments, does not extend through all of the plurality of sides. The wheel support can have a reduced perimeter at the cutout as compared to a perimeter of at least one of the continuous surfaces on either side of the cutout, both perimeters being defined by a plane perpendicular to the longitudinal axis. The damping member can be positioned within and fill the cutout to continue the shape of the outer surface defined by the perimeter of at least one of the continuous surfaces on either side of the cutout. The plate can force the damping member into contact with the outer surface of the wheel support at the cutout with at least a portion of the damping member sandwiched between the plate and the wheel support to thereby dampen vibrations introduced to the wheel support by the wheel.

### BRIEF DESCRIPTION OF THE DRAWINGS

These and other features, aspects and advantages are described below with reference to the drawings, which are intended to illustrate but not to limit the invention. In the drawings, like reference characters denote corresponding features consistently throughout similar embodiments.

FIG. 1 is a side elevation view of a bicycle.

FIG. 2 is a perspective view of a front fork assembly.

FIG. 3 is a front view of a portion of a bicycle and front fork assembly of FIG. 2.

FIG. 4 is a cross-section view of a portion of the front fork assembly of FIG. 2 taken along line 4-4 of FIG. 3.

FIG. 5 is a perspective view of a portion of a partially disassembled front fork assembly.

FIG. 6 is a perspective view of a part of a rear frame portion.

FIG. 7 is a perspective partially disassembled view of a part of the rear frame portion of FIG. 6.

FIG. 8 is a cross-section view of the portion of a rear frame portion of FIG. 6 taken along line 8-8.

### DETAILED DESCRIPTION OF THE PREFERRED EMBODIMENT

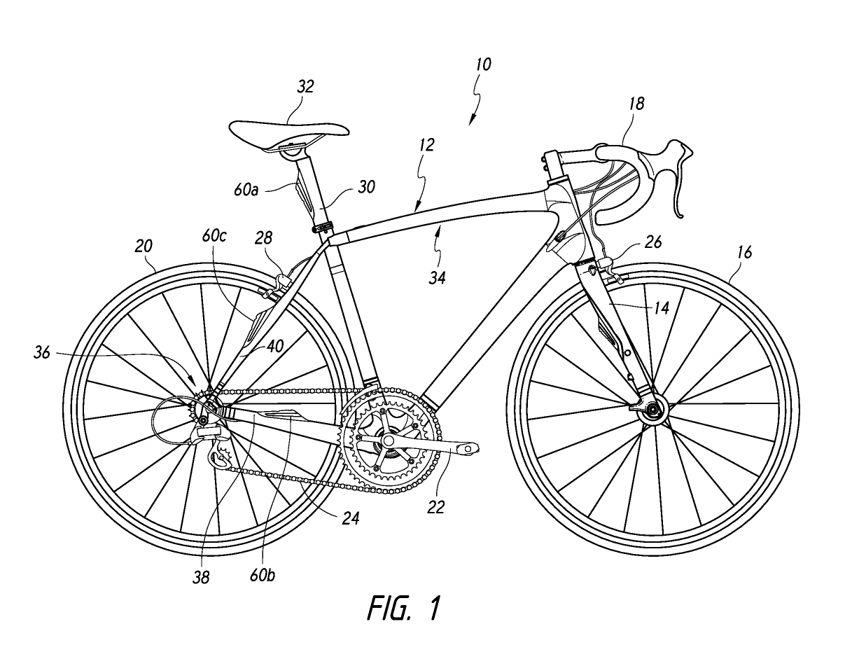

FIG. 1 illustrates a bicycle, which is referred to generally by the reference numeral 10. The bicycle 10 includes a frame 12, which rotatably supports a wheel support, or front fork assembly 14, near a forward end of the frame 12 for rotation about a steering axis. A lower end of the fork assembly 14 supports a front wheel 16 of the bicycle 10. A handlebar assembly 18 is connected to an upper end of the fork 14 for rotating the fork assembly 14 and front wheel 16 about the steering axis of the bicycle 10. In addition, the handlebar assembly 18 may include one or more rider controls, such as shifting or braking controls.

A rear wheel 20 of the bicycle 10 is supported near a rearward end of the frame 12. A pedal crank assembly 22 is rotatably supported by a lower portion of the frame 12. A drive chain 24 extends between the pedal crank assembly and the rear wheel to transfer power therebetween, as is well known in the art.

A front brake caliper 26 can be supported by the front fork assembly 14 and is configured to selectively apply a squeezing force to a rim of the front wheel 16. Similarly, a rear brake caliper 28 can be supported by the frame 12 and configured to selectively apply a squeezing force to a rim portion of the rear wheel 20. Alternatively, other types of braking systems may also be used.

A seat post 30 extends in an upward direction from the frame 12 and supports a seat 32 on its upper end. The seat post 30 may be adjusted in height relative to the frame 12 to adjust a seat height of the bicycle 10.

Preferably, the frame 12 includes a main frame portion 34 and a wheel support, or rear frame portion 36. The rear frame portion 36 desirably includes a pair of lower legs, or chain stay members 38 (only one shown), extending on each side of the rear wheel 20 from a lower portion of the main frame 34. In addition, the rear frame portion 36 includes a pair of upper legs, or seat stay members 40, extending from an upper portion of the main frame 34 on each side of the rear wheel 20 and being connected to a rear end of the chain stays 38 near a hub axis of the rear wheel 20.

At least the main frame 34 can be constructed from a plurality of tubular, metal pieces welded together. For example, the main frame 34 may be constructed from aluminum, steel or titanium tubing. Alternatively, the frame may comprise a composite material and may be constructed as a unitary piece or multiple pieces bonded or molded together. In addition, other suitable materials and/or construction methods may also be used, as will be appreciated by one of skill in the art.

As described above, the front fork assembly 14 preferably is constructed to reduce the amount of vibration passed from the front wheel 16 to the handlebar assembly 18, and thus the rider of the bicycle 10. Additionally, other components of the bicycle 10 may also be constructed to reduce vibration transfer. For example, the seat post 30 may be constructed to include a damping system 60a (FIG. 1), to reduce the transmission of vibrations from the frame 12 to the seat 32 and, thus, the rider of the bicycle 10. Furthermore, other components and/or portions of the bicycle 10, such as the chain stays 38 or seat stays 40 of the frame 12, may be similarly arranged to include a damping system 60b, 60c, respectively, to reduce the transmission of vibrations from the wheels 16, 20 to the rider of the bicycle 10, as will be appreciated by one of skill in the art in light of the teachings of the present application.

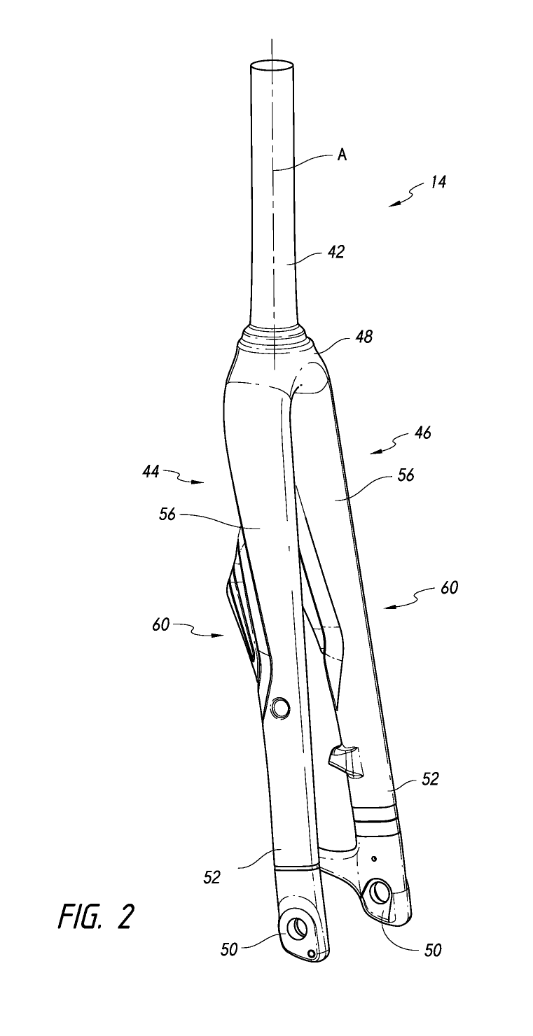

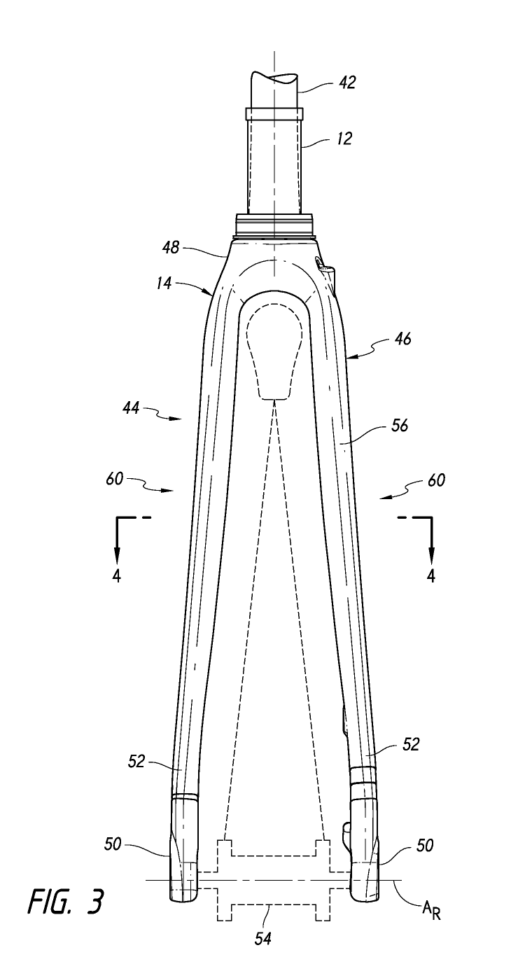

With reference to FIGS. 2 and 3, one embodiment of a front fork 14 is illustrated in greater detail. In FIG. 2, the front wheel 16 has been omitted and in FIG. 3, the front wheel 16 is shown in phantom for the purpose of clarity. As is described in greater detail below, preferably, the fork 14 can be constructed as a composite of a plurality of sheets of a carbon fiber material within an epoxy resin matrix and incorporates a vibration damping system 60 that can include an elastomeric material. Preferably the elastomeric material comprises a thermoplastic elastomer, and more preferably a viscoelastomeric material, as is described in greater detail below.

A steer tube 42 of the front fork assembly 14 extends through the frame 12 of the bicycle 10 and supports the handlebar assembly 18 (FIG. 1) at its upper end. A pair of fork legs 44, 46 extend downward from the steer tube 42 on opposing sides of the front wheel 16. The fork legs 44, 46 are interconnected at an upper end 48, which is also connected to the steer tube 42. An intermediate portion 56 of the fork legs 44, 46 connects the upper portion 48 to the lower portion 52. Thus, each fork leg 44, 46 is a generally rigid member that defines a substantially constant length. That is, preferably, the fork assembly 14 is constructed such that relative movement between the front wheel 16 and the bicycle frame 12 along the axis of the fork leg is substantially prevented. Such a construction is commonly referred to as an unsuspended, or rigid, fork assembly. Furthermore, desirably, the fork legs 44, 46 and the steer tube 42 are of a one-piece construction.

A drop out 50 is secured to or integrally formed with a lower end 52 of each fork leg 44, 46. The drop outs 50 are sized and shaped to receive an axle portion of a hub 54 of the front wheel 16. In one arrangement, the drop outs 50 are constructed of a metal, such as aluminum or steel, and are secured to the fork legs 44, 46 by a bonding process. In another arrangement, the dropouts 50 are integrally formed with the fork legs 44, 46 of a carbon fiber material. However, other suitable arrangements to connect the front wheel 16 to the fork assembly 14 may also be used.

With reference to FIGS. 1 and 2, desirably, the fork legs 44, 46 are arranged such that the hub 54 is supported on a forward side of an axis A defined by the steer tube 42. This is commonly referred to as the “rake” or offset of the fork 14. Such an arrangement adjusts the stability of the handling characteristics of the bicycle 10, as is well known in the art.

As mentioned previously, a damping system 60 can be used to reduce and isolate terrain-induced vibrations from reaching the rider of the bicycle. A damping system 60 can be used on a wheel support, such as, at least one of each fork leg 44, 46, the seat post 30, each seat stay 40 and each chain stay 38. As will be shown, the damping system 60 can be configured to force a damping member into contact with a component of the bicycle, for example, a fork leg. In addition, as also will be shown, the damping system 60 can be configured to sandwich a damping member between a component of the bicycle, for example, a fork leg, and a second member such as a fastener or plate. In some embodiments, the second member can force the damping member into contact with the component. In some embodiments, a damping member can be forced into contact with the component, such as with a fastener that secures the damping member to the component. For example, a damping member can be sandwiched between a plate and a component and can be forced into contact with the component with a fastener that secures to the plate and/or to the component or that further sandwiches the component between the plate and fastener.

In some embodiments, the fastener can be part of the plate, such as a protrusion and/or snap fit that extends from the plate. Alternatively, or in addition, the fastener or part of the fastener can be made integrally with the damping member. A fastener may be directly attached to the damping member. The fastener can be threaded, snap fit, or other type of fastener and can also include one or more fasteners. The plate can be a rigid plate. The plate can contact substantially all, a majority of, or some of a surface of the damping member that is not contacting the component. Other embodiments and configurations can also be used, a few examples of which follow below.

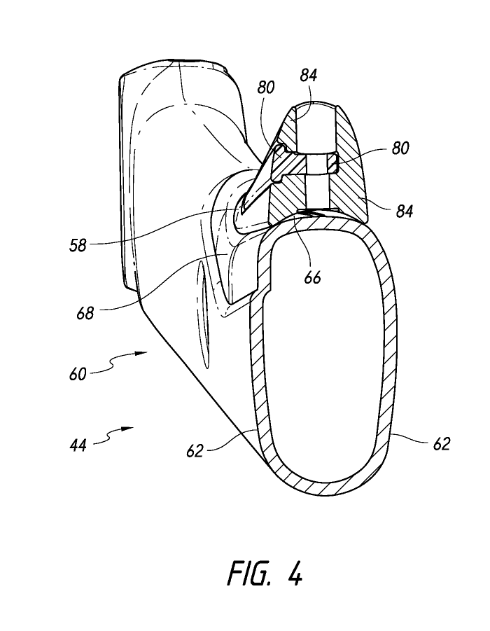

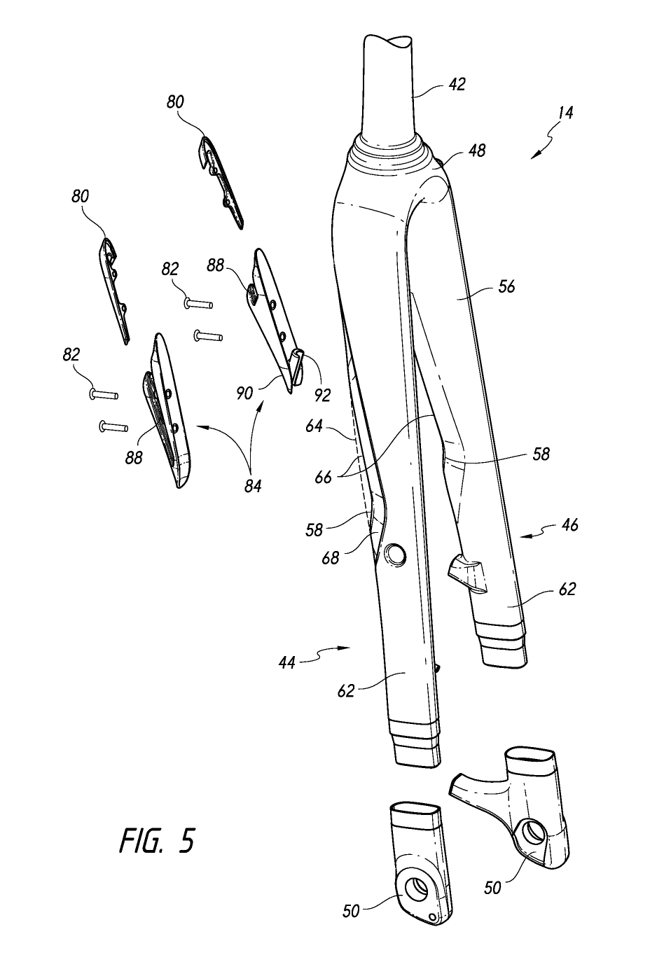

Looking now to FIGS. 4-5, one embodiment of a damping system 60 has a damping member 84 on an outer surface 62 of a fork leg 44, 46. A plate 80 secures the damping member 84 in place and forces the damping member 84 into contact with the outer surface of the fork leg. This forced contact with the surface of the fork leg helps to ensure a resulting damping effect. Further, one or more fasteners 82 can be used to secure the plate and damping member to the fork leg. As mentioned previously, the damping member 84 can be an elastomeric material.

A wheel support, such as the illustrated legs 44, 46, can extend along a longitudinal axis and can have a wheel support length. In the illustrated embodiment, the wheel support length can be the length of the fork or the length of one of the fork legs. In other embodiments, the wheel support length may be the length of the seat post 30, seat stay 40, chain stay 38, some other portion of the rear triangle, etc.

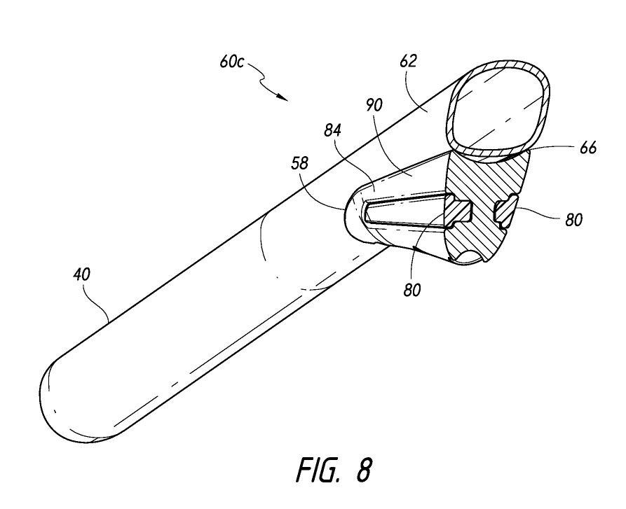

The wheel support can have an outer surface forming a plurality of sides extending along the wheel support length. The plurality of sides of the wheel support can form any number of different shapes. For example, the a cross-section defined by a plane perpendicular to the longitudinal axis can be a circle, oval (FIG. 4), a rounded square (FIG. 8), rectangle, triangle, etc. In some embodiments, the plurality of sides can comprise four sides. The four sides can be front, back, right, and left, or top, bottom, right, and left, or the faces of the component, or four quadrants, such as four quadrants of a circle, etc.

The outer surface 62 of the fork leg 44, 46 can be shaped or contoured to provide a location for the damping member 84. In particular, a space or cutout 66 can be provided in the leg for the damping member 84. The cutout 66 can take many forms. As illustrated, the cutout 66 can be a necked down region of the fork leg. Thus, the leg can have an area with a smaller diameter, perimeter, cross-section, etc. as compared to an adjoining area, or as compared to adjoining areas on either side of the space or cutout 66.

For example, the leg can have a reduced perimeter at the cutout as compared to a perimeter of at least one of the continuous surfaces on either side of the cutout, both perimeters being defined by a plane perpendicular to the longitudinal axis. The cross-section of FIG. 4 illustrates one of the reduced perimeters. As the illustrated leg is a hollow tube, it will be understood that the perimeter at locations before and after the cutout will be larger than the respective perimeter of the adjacent regions within the cutout. As another example, the outer surface 62 can be shaped to form a cutout 66 from a continuous surface on either side of the cutout wherein a line 64 extending at a top of the cutout from a first end to a second end of the cutout along the wheel support length can align with the continuous surface on either side of the cutout 66.

In some embodiments, the cutout 66 can include one or more shoulders 58, though preferably there are only one or two shoulders. In the illustrated embodiment, the cutout 66 includes a shoulder 58 on one end, while the other end forms a more gradual decrease in size. The outer surface can define a first outer perimeter and a second outer perimeter smaller than the first, both perimeters being defined by a plane perpendicular to the longitudinal axis. The outer surface can form a shoulder along a first side of the leg between the first and second outer perimeters while a second side of the leg opposite the first side does not form a shoulder and/or extends continuously without interruption. In FIG. 4, the side on the bottom of the drawing is this second side, which as viewed in FIG. 5 is the front of the fork. Thus, the illustrated cutout does not extend through all of the sides. The cutout is predominately on the back side and may only form a minor or small portion of the left and right sides.

The cutout 66 is illustrated having a triangular- or “V”-shape, though other shapes can also be formed such as a half circular-, “U”-, or “W”-shape. Also, one or more inward extending bumps may form the cutout 66. It will be understood that the term “cutout” does not require a particular manufacturing process that would cut out some portion of material. Rather, “cutout” refers generally to a gap or space in a component, the illustrated embodiments being only a few examples.

Beneficially, the illustrated cutouts 66 do not require complex geometry in the component, such as the fork leg. As can be seen in the cross-section of FIG. 4, the basic shape of a simple tube can be maintained at the cutout, as well as along the rest of the component as desired. In this way, a damping system can be employed in a simple manner without greatly increasing the manufacturing process. At the same time, the component can maintain other qualities, such as strength and rigidity because the component is not required to have a complex geometry which may have a greater likelihood to introduce weakness, bending moments, or other considerations. Thus, in the preferred embodiment, the cutout has a limited number of walls, such as a bottom wall and one or more shoulders. It will be understood that the bottom wall can be contoured to take on various shapes, though preferably there is not a side wall to create an enclosed area with the one or more shoulders or other walls.

In some embodiments, the cross-section of the tube at the cutout, as well as at regions adjacent the cutout, can be a rounded rectangle (FIG. 4), a circle, a rounded square (FIG. 8), a trapezoid, a triangle, etc. The shape will preferably be rounded, though hard edges may also be employed along one or more edge or corner.

A small indentation 68 is also illustrated on one side of the fork leg. The indentation 68 can be considered part of the cutout 66, though this is not required.

As has been mentioned, a damping member 84 can be positioned within the cutout 66. The damping member may preferably fill all or a majority of the cutout. For example, a damping member 84 can be positioned on the outer surface at the shoulder 58. The damping member can be positioned at the necked down region of the fork leg. Thus, the damping member can be position on the outer surface at the area with the smaller diameter, perimeter, cross-section, etc. as compared to an adjoining area, or as compared to adjoining areas on either side of the space or cutout 66.

The damping member may contact only, or predominately only, one side of the outer surface. In the illustrated embodiment, the damping member 84 is primarily in contact with the back side and only a small portion is in contact with the right and left sides. Thus, the illustrated damping member does not extend to all sides of the component, or all the way around; though it will be understood, that other designs of damping member can be used that would extend all the way around.

The damping member can be positioned within and fill the cutout. In some embodiments, the damping member can continue the shape of the outer surface defined by the perimeter of at least one of the continuous surfaces on either side of the cutout. In some embodiments, the damping member can initially continue the shape of the outer surface and then a new shape can be introduced. For example, as can be seen in FIG. 2, the bottom of the damping member is essentially aligned with the outer surface of the fork leg, but then extends outward therefrom.

The cross-section of the damping member 84 can have any of a variety of shapes. For example, the damping member 84 can be wedge shaped or trapezoidal. The shape of the cross-section can allow for increased contact with the surface cavity 66 and can increase the effectiveness of the bolt tension and the sandwiching effect to press the damping member 84 into contact with the fork leg and reduce transmitted vibrations. As shown, the damping member is wedge shaped with a larger portion of the wedge closer to the top or to the seat of the bicycle than the smaller portion. Other shapes can also be employed.

Desirably the damping member 84 is substantially solid and, preferably, is completely solid. Such an arrangement advantageously provides consistent, uniform vibration damping performance of the damping system 60. In addition, desirably, the cross-sectional area of the damping member 84 is great enough to effectively dampen vibrations from reaching the rider of the bicycle 10.

In some embodiments, the damping member 84 can also include a cable guide 92 (FIG. 5). The cable guide 92 can be used to assist with internal routing of cables, such as brake cables, or derailleur cables.

As best seen in FIGS. 4 and 5, the damping system 60 can also include a plate 80. The plate 80 can force the damping member 84 into contact with the outer surface 62 of the wheel support, such as the fork leg 44, 46. At least a portion of the damping member 84 can be sandwiched between the plate 80 and the wheel support to thereby dampen vibrations introduced to the wheel support by the wheel.

The plate 80 can be positioned on top of the damping member 84. In other embodiments, the plate can be positioned within the damping member. For example, the plate can be embedded within the damping member and/or portions of the damping member can be on one, two or more sides of the plate.

The damping member 84 can have an outer wall 90 defining a cavity 88. The plate 80 can be contoured to fit within and be positioned within the cavity 88.

A cavity can be a depressed portion in the damping member. The depressed portion can be depressed relative to a surrounding surface. The depressed portion may not pass all the way through the damping member and can have a back wall and side walls. In other embodiments, the depressed portion can be rounded or pointed so that the transition between the side walls and back wall may not be clearly defined. In addition, the side walls may also form the back wall, such as when the side walls form a “V” within the depression. The depressed portion can be any number of shapes and can be configured to maximize contact between the plate and the damping member, and between the damping member and the component. The depressed portion can be formed in many ways, such as being integrally formed with the component or material may be removed to form the depressed portion. In addition, the depressed portion can extend along the surface between two or more sides of the component.

The plate 80 can be contoured to fit within and positioned within the cavity 88, thereby extending along the outer wall 90 between opposing sides of the outer wall. In some embodiments, the plate extends along the outside of the cavity. The plate can be positioned partially or entirely within the cavity 88. For example, the plate can be essentially co-extensive with the cavity or the plate can extend past the cavity such that only a portion of the plate is positioned within the cavity and a portion of the plate extends along a surface of the damping member outside of the cavity.

The plate 80 is shown as J-shaped, but can also be C-shaped, U-shaped, flat, etc., so that the plate extends along the surface of the damping member from one side of the component to another side. The plate can also be co-extensive with the damping member, or may cover a greater or smaller area than the damping member.

A fastener 82 can pass through the plate 80 and damping member to secure the damping system 60 to the component. The fastener 82 can engage a tubular rivet with internal threads, such as a threaded RIVNUT or other nut. The fastener can be part of the plate, such as a protrusion and/or snap, or a separate threaded, snap fit, or other type of fastener. The fastener 82 may also include one or more fasteners. Bolt tension can compress the damping member 84 into contact with the surface of the fork leg allowing the damping member to influence the vibrations being transmitted through the fork leg.

In other embodiments, fasteners can be used to connect directly to the damping member. For example, a fastener can connect to a damping member in a similar manner as shown in FIG. 4 but without the plate. The damping member can be a solid piece that accepts the fastener into the damping member or the fastener may pass through the damping member.

The damping member can also be formed with one or more projections. The projections can be configured to hold the damping member in place. In some embodiments, the projections can have a head, flange, or other contact surface on an end. The head can be used to maintain the damping member in place, similar to a head on a fastener. In this way, the projections can be used in place of or in addition to one or more fasteners. The projection with a head or contact surface can also be used to force the damping member into contact with the fork leg or other component and result in a damping effect.

Preferably, the damping system 60 is located within the intermediate portion 56 of each fork leg 44, 46. The damping member 84 can be elongated and/or contoured or otherwise shaped so as to advantageously maximize the contact area between the damping member 84 and the fork leg 44, 46 within the space available, which enhances vibration damping, while preserving the strength and stiffness of the fork 14, which improves handling.

Although not shown in detail, desirably, the left fork leg 46 can be substantially a mirror image of the left fork leg 44. However, as will be readily appreciated by one of skill in the art, in other aspects the damping system 60 of the left fork leg 46 can be substantially identical to that described above.

When constructed substantially as described in any of the embodiments above, the fork assembly inhibits or reduces vibrations from passing through the fork legs 44, 46. Thus, vibrations originating at the lower end 52 of the fork legs 44, 46 (i.e., at the front wheel 16) are inhibited, or reduced in magnitude, from passing to the upper ends 48 and steer tube 42 of the fork and, thus, the handlebar 18 of the bicycle 10. Such an arrangement improves the comfort of the rider and reduces fatigue during long rides.

Preferably, the entire fork assembly, with the exception of the damping system, is constructed in a manner conventional for composite bicycle forks. However, the fork assembly may be constructed by any other suitable method. Advantageously, the fork assembly can be lighter weight than prior fork assemblies that used damping systems with an insert, such as where a cavity passed all the way through the fork, or where the cavity created a complex geometry. This is because of the simplicity of creating the cutout. Similar benefits are also experienced in use with the damper system 60 in other areas of the bicycle, such as the seat stays, seat tube, and chain stays.

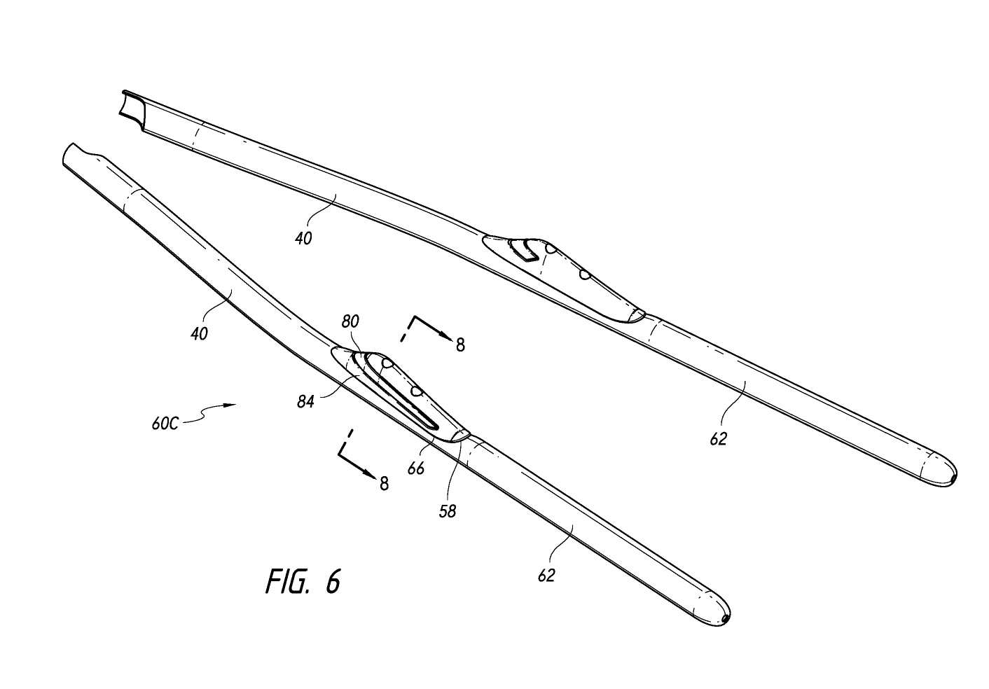

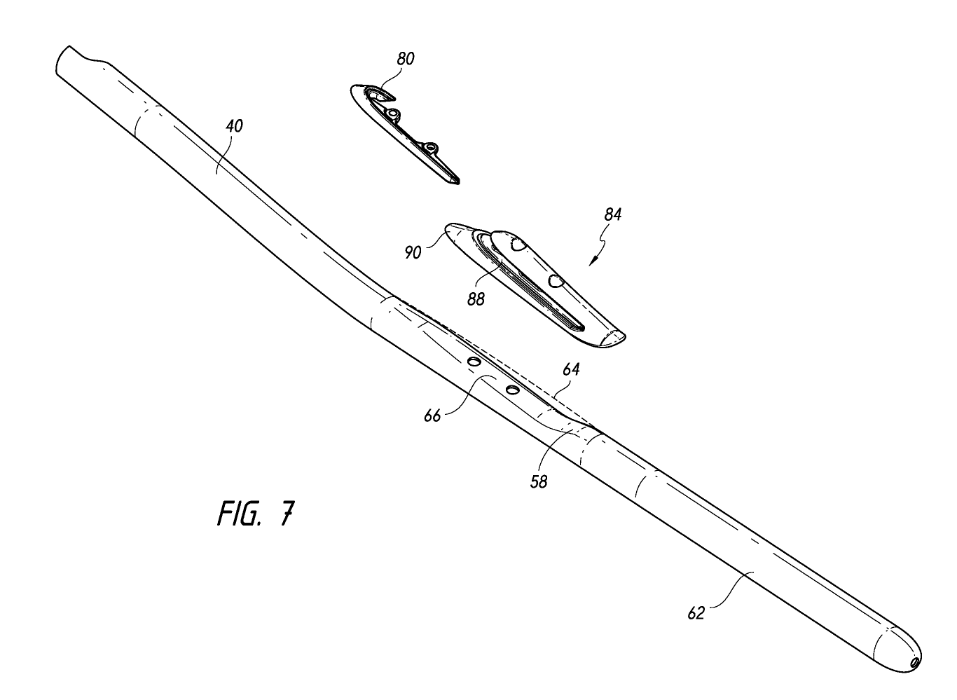

Turning now to FIGS. 6-8, an embodiment of a damping system 60c is shown, in use with the seat stays 40 of a rear frame portion 36. As shown, the damping member 84 is placed into a cutout 66 in the seat stay 40. A threaded fastener (not shown) secures a plate 80 and damping member 84 in place and thereby forces the damping member 84 into contact with the surface of the seat stay 40. Thus, the damping member 84 is sandwiched between the seat stay 40 and the plate 80. The bolt tension can compress the damping member 84 into contact with the surface of the seat stay 40 allowing the damping member to influence the vibrations being transmitted through the seat stay 40. This forced contact with the surface of the seat stay 40 helps to ensure a resulting damping effect.

As shown, the damping member 84, plate 80, and cutout 66 are similarly shaped to the embodiments described above with respect to the fork. The cutout 66 forms a shoulder 58 at one end and the other end provides a more gradual change in shape. The damping member 84 is positioned in the cutout 66 and is primarily on one side (the top) of the seat stay, though a small portion only extends to the right and left sides. It will be understood that parts of the damping system 60 can extend across various surfaces of the component. For example, parts of the damping system could wrap around two or more sides of the seat stay 40.

The plate 80 is shown as J-shaped, but can also be C-shaped, U-shaped, flat, etc., so that the plate extends along the surface of the damping member from one side of the component to another side. The plate can be co-extensive with the damping member, or may cover a greater or smaller area than the damping member. In some embodiments, the damping member 84 can further include a cavity 88. The plate 80 can be inserted into the cavity 88. Similar to the fork leg, the seat stay 40 can be of a thin wall, hollow construction to reduce weight. The seat stay 40 also has an outer surface 62. The fastener 82 can be advanced through the damping member 84 and plate 80 from the top towards the seat stay to attach to a threaded rivet or other nut.

In other embodiments, fasteners can be used to connect directly to the damping member. Alternatively, the damping member can be formed with one or more projections, such as projections with a head, flange, or other contact surface. The projection with a head or other contact surface can be used to compress the damping member into contact with the seat stay or other component and result in a damping effect. Thus, the projections can function in the same or a similar way as a fastener.

Preferably, the damping system 60 is located within the intermediate portion of each seat stay 40. The damping member 84 can be elongated and/or contoured or otherwise shaped so as to advantageously maximize the contact area between the damping member 84 and the seat stay 40 within the space available, which enhances vibration damping, while preserving the strength and stiffness of the seat stay 40.

When constructed substantially as described in any of the embodiments above, the rear frame portion with damping system inhibits vibrations from passing through the seat stays 40. Thus, vibrations originating at the lower end of the seat stays (i.e., at the back wheel 20) are inhibited from passing to the upper ends and to the main frame 34. Such an arrangement improves the comfort of the rider and reduces fatigue during long rides.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A bicycle, comprising:
a main frame portion;
a wheel;
a wheel support coupled to the main frame portion at a first end and supporting the wheel at a second end, a distance between the first end and the second end defining a wheel support length along a longitudinal axis, the wheel support having an outer surface forming a plurality of sides extending along the wheel support length,
the outer surface defining a first outer perimeter and a second outer perimeter smaller than the first, both perimeters being defined by a plane perpendicular to the longitudinal axis, the outer surface forming a shoulder along a first side of the plurality of sides between the first and second outer perimeters while a second side opposite the shoulder, does not form a shoulder;
a damping member positioned on the first side of the outer surface at the shoulder and generally positioned adjacent a portion of the second outer perimeter;
a plate; and
one or more fasteners;
wherein the plate forces the damping member into contact with the first side of the outer surface of the wheel support with at least a portion of the damping member sandwiched between the plate and the wheel support to thereby dampen vibrations introduced to the wheel support by the wheel.

2. The bicycle of claim 1, wherein the wheel support is one of a fork, a fork leg, a rear frame portion, a seat stay and a chain stay.

3. The bicycle of claim 1, wherein the shoulder is located in an intermediate portion of the wheel support between the first and second ends.

4. The bicycle of claim 1, wherein the wheel support comprises a cutout extending from the shoulder at one end to a second end spaced therefrom.

5. The bicycle of claim 1, wherein the damping member has an outer wall defining a cavity and the plate is positioned within the cavity.

6. The bicycle of claim 1, wherein the plate is embedded within the damping member.

7. The bicycle of claim 1, further comprising a second damping member.

8. The bicycle of claim 7, wherein the two damping members are on separate portions of the wheel support, positioned on either side of the wheel.

9. A bicycle, comprising:
a main frame portion;
a wheel;
a wheel support coupled to the main frame portion at a first end and supporting the wheel at a second end, a distance between the first end and the second end defining a wheel support length along a longitudinal axis, the wheel support having an outer surface forming a plurality of sides extending along the wheel support length,
the outer surface shaped to form a cutout from a continuous surface on either side of the cutout wherein a line extending at a top of the cutout from a first end to a second end of the cutout along the wheel support length aligns with the continuous surface on either side of the cutout, the cutout not extending through all of the plurality of sides, the wheel support having a reduced perimeter at the cutout as compared to a perimeter of at least one of the continuous surfaces on either side of the cutout, both perimeters being defined by a plane perpendicular to the longitudinal axis;
a damping member positioned within and filling the cutout to continue the shape of the outer surface defined by the perimeter of at least one of the continuous surfaces on either side of the cutout
a plate; and
one or more fasteners;
wherein the plate forces the damping member into contact with the outer surface of the wheel support at the cutout with at least a portion of the damping member sandwiched between the plate and the wheel support to thereby dampen vibrations introduced to the wheel support by the wheel.

10. The bicycle of claim 9, wherein the wheel support is one of a fork, a fork leg, a rear frame portion, a seat stay and a chain stay.

11. The bicycle of claim 9, wherein the outer surface at one end of the cutout forms a shoulder.

12. The bicycle of claim 9, wherein the cutout does not extend into at least one of the plurality of sides.

13. The bicycle of claim 9, wherein the cutout is located in an intermediate portion of the wheel support between the first and second ends.

14. The bicycle of claim 9, wherein the damping member has an outer wall defining a cavity and the plate is positioned within the cavity.

15. The bicycle of claim 9, wherein the plate is embedded within the damping member.

16. The bicycle of claim 9, further comprising a second damping member.

17. The bicycle of claim 16, wherein the two damping members are on separate portions of the wheel support, positioned on either side of the wheel.
